(19) United States
(12) Patent Application Publication
(10) Pub. No.: US 2009/0302492 A1
(43) Pub. Date: Dec. 10, 2009

(54) In-mold reprint manufacturing system for thin film texture and a method thereof

(76) Inventors: Chun-Yen Hung, Taipei Hsien (TW); Chu-Chia Tsai, Taipei Hsien (TW); Ya-Chi Hsiao, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,822

(22) Filed: Aug. 18, 2008

(30) Foreign Application Priority Data
Jun. 4, 2008 (TW) 97120726

(51) Int. Cl. B29D 7/01; B29C 43/52; B29C 45/33; B29C 43/32

(52) U.S. Cl. 264/166; 425/177

(57) ABSTRACT

An in-mold reprint manufacturing system for thin film texture includes a texture reprint device having a first mold and a second mold and an injection molding machine having a foil feeder, a foil feeder rewinder, a cavity moving plate, and a core fastening plate. The first mold and the second mold of the texture reprint device are pressed onto a thin film to generate a texture on the thin film. The foil feeder and the foil feeder rewinder continuously make the thin film with the texture pass through the core fastening plate. The cavity moving plate has a repeated movement to the core fastening plate to produce a product with the texture by the injection molding way. An in-mold reprint manufacturing method for thin film texture is also disclosed.

### BACKGROUND OF THE INVENTION

1. Field of the Invention

The present invention relates to an in-mold reprint (IMR) manufacturing system for thin film texture and a method thereof In particular, the present invention relates to a manufacturing system that uses the in-mold reprint (IMR) technology to produce the texture on the thin film and a manufacturing method thereof.

2. Description of the Related Art

As the consumer electronic devices develop rapidly, the appearance of the digital devices is a key factor to attract consumers, which is especially true for the casing of the devices. The design of the casing, in addition to provide a first expression to the consumer, also affects the materials (reducing the hazardous materials), the manufacturing methods, the finishing processes, and manufacturing processes (reducing the processes) that applies to the casing of the modern 3C devices (including computer, communication, and consumer electronic devices), and these methods and processes have improved drastically over the years. Therein, in order to improve the vision effect and the surface texture of the casing of the 3C devices, a variety of the surface process technologies have developed, such as in-mold reprint (IMR), vacuum sputter, and anodic treatment, etc.

Taiwan patent, 1273965, provides a method of forming a pattern thin film structure for the in-mold decoration (IMD). The method includes the following steps. The detachable material composed of adhesive and 5˜80% dispersible particles is used to print the pattern on the substrate. The printed detachable material defines the negative image for the decoration on the substrate so that the printed detachable material exists on the area of the substrate that does not form the thin film. The printed detachable material does not exist on the area of the substrate that forms the thin film. The thin film is deposited on the patterned substrate. The detachable material is removed from the substrate. By removing the detachable material and the thin film material formed on the detachable material, the thin film structure for the decoration is formed on the substrate. The substrate and the patterned thin film formed on the substrate can be applied to the in-mold decoration (IMD).

Furthermore, U.S. Pat. No. 6,732,642, discloses “auto screen-printing method for use in IMR and injection molding”. The method includes the following steps. By using the auto screen-printing and the drying processes, the transparent harden additive is pressed and printed on the PET thin film. Four colors and the harden additive are orderly printed on the PET thin film and dried. The back-film is printed by the screen-printing and is dried. Next, the device is injected.

In order to produce a three-dimensional thin film, the in-mold reprint of the prior art uses the chemical way to print the pattern on the thin film, or produce the texture on the injected mold. However, the mold merely can produce a single text. For the device with multiple textures, the manufacturing cost is high, and the manufacturing process is complex. The yield rate is low. Moreover, the equipments for the vacuum sputter and the anodic treatment are expensive so that the manufacturing cost increases.

### SUMMARY OF THE INVENTION

One particular aspect of the present invention is to provide an in-mold reprint (IMR) manufacturing system for thin film texture and a method thereof to generate the texture on the thin film. The manufacturing cost is reduced, the manufacturing process is simplified, and the yield rate is improved.

The in-mold reprint manufacturing system for thin film texture includes a texture reprint device having a first mold and a second mold, and an injection molding machine having a foil feeder, a foil feeder rewinder, a cavity moving plate, and a core fastening plate. The first mold and the second mold of the texture reprint device are pressed onto a thin film to generate a texture on the thin film. The foil feeder and the foil feeder rewinder continuously make the thin film with the texture pass through the core fastening plate. The cavity moving plate has a repeated movement to the core fastening plate to produce a product with the texture by the injection molding way.

The present invention also provides an in-mold reprint manufacturing method for thin film texture. The in-mold reprint manufacturing method for thin film texture includes the following steps. A thin film is moved to the surface of a first mold. After the thin film is processed by the heating process, a second mold and the first mold are pressed onto the thin film to produce the texture on the thin film. The thin film with the texture is injected to produce a product with the texture.

The present invention has the following characteristics:

1. By utilizing the design of the mold, the manufacturing cost is reduced, and the manufacturing process is simplified.

2. By changing the texture of the thin film, the thin film with the texture has the versatile vision effect and a three-dimensional touch feeling (i.e. 3D texture).

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a schematic diagram of the texture reprint device of the in-mold reprint manufacturing system for thin film texture of the first embodiment of the present invention;

FIG. 2 is a schematic diagram of the injection molding machine of the in-mold reprint manufacturing system for thin film texture the of first embodiment of the present invention;

FIG. 3 is a flow chart of the in-mold reprint manufacturing method for thin film texture of the first embodiment of the present invention;

FIG. 4 is a schematic diagram of the texture reprint device of the in-mold reprint manufacturing system for thin film texture of the second embodiment of the present invention;

FIG. 5 is a schematic diagram of the texture reprint device of the in-mold reprint manufacturing system for thin film texture of the third embodiment of the present invention;

FIG. 6 is a schematic diagram of the texture reprint device of the in-mold reprint manufacturing system for thin film texture of the fourth embodiment of the present invention;

FIG. 7 is a first diagram of the molded product by the in-mold reprint manufacturing method for thin film texture of the present invention;

FIG. 8 is a second diagram of the molded product by the in-mold reprint manufacturing method for thin film texture of the present invention;

FIG. 9 is a third diagram of the molded product by the in-mold reprint manufacturing method for thin film texture of the present invention;

FIG. 10 is a fourth diagram of the molded product by the in-mold reprint manufacturing method for thin film texture of the present invention; and

FIG. 11 is a fifth diagram of the molded product by the in-mold reprint manufacturing method for thin film texture of the present invention.

### DETAILED DESCRIPTION OF THE PREFERRED EMBODIMENTS

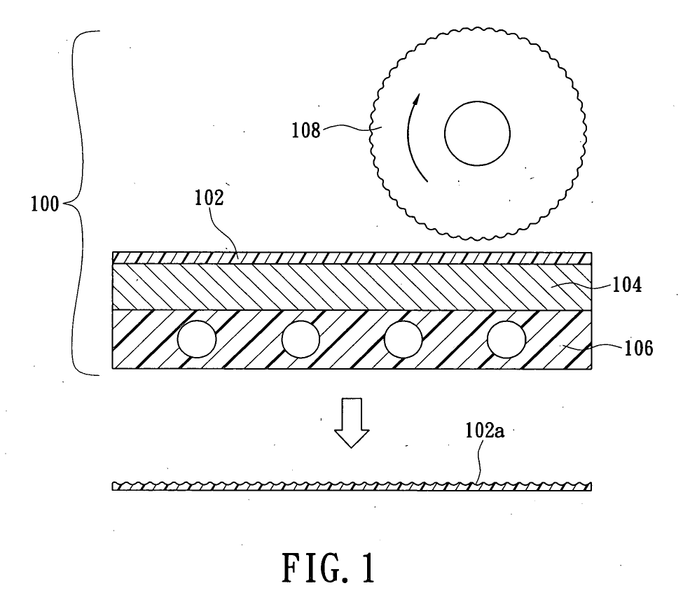

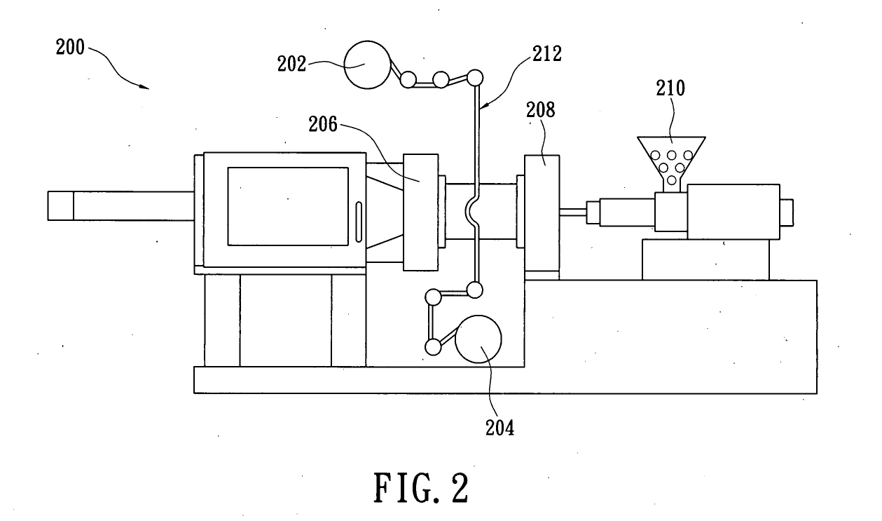

Reference is made to FIGS. 1 and 2. The in-mold reprint (IMR) manufacturing system for thin film texture of the present invention includes a texture reprint device 100, and an injection molding machine 200.

The texture reprint device 100 has a first mold 104 and a second mold 108. The first mold 104 and the second mold 108 of the texture reprint device 100 are pressed onto a thin film 102 to generate a texture on the thin film 102a. The thin film 102 is made of PVC, PET, or PC. The thin film 102 is processed by a general process and includes a separated-type layer, a hardening layer, a print ink layer, an evaporation-plating layer, and an attaching layer. In this embodiment, the thin film 102 does not contain the print ink layer after the thin film 102 is processed by a general process.

The first mold 104 is a board. The board is made of copper, stainless steel, or silicon rubber. One surface of the board has the texture with different design pattern. In this embodiment, the board is a smooth surface. The first mold 104 further has a heater 106. The heater 106 is located on the lower surface of the first mold 104.

The second mold 108 is a roller, or another board. The roller or the board is made of copper, stainless steel, or silicon rubber. In this embodiment, the second mold 108 is a roller. Referring to FIG. 1, one surface of the roller has a texture.

The injection molding machine 200 includes a foil feeder 202, a foil feeder rewinder 204, a cavity moving plate 206, and a core fastening plate 208. The foil feeder 202 and the foil feeder rewinder 204 continuously make the thin film 212 with the texture (the same as the thin film 102a with the texture in FIG. 1) pass through the core fastening plate 208. The cavity moving plate 206 has a repeated movement to the core fastening plate 208 and adds the resin 210 to produce a product with the texture by the injection molding way. The product is a casing (i.e. housing) of a consumer electronic device, such as a casing of laptops, a casing of PDAs, or a casing of cell phones.

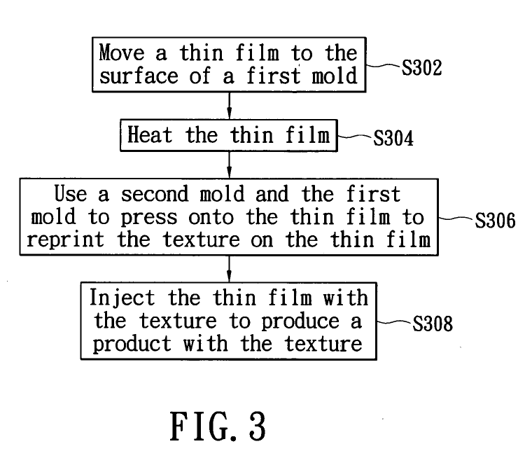

Reference is made to FIG. 3, which shows the flow chart of the in-mold reprint manufacturing method for thin film texture of the present invention. The in-mold reprint manufacturing method for thin film texture includes the following steps.

The step S302 is executed. Referring to FIG. 1, a thin film 102 is moved to the surface of a first mold 104.

The step S304 is executed. The thin film 102 is processed by the heating process. The heating process to the thin film 102 is implemented by the heater 106. The heating temperature from the heater 106 is between 200° and 300°. Therefore, the thin film 102 becomes soft and can be easily processed by the texture reprint.

The step S306 is executed. A second mold 108 and the first mold 104 are pressed onto the thin film 102 to produce the texture on the thin film 102. Therefore, the thin film 102a with the texture is produced.

The step S308 is executed. The thin film 102 with the texture is injected to produce a product with the texture. Referring to FIG. 2, the product is produced by the injection molding machine 200.

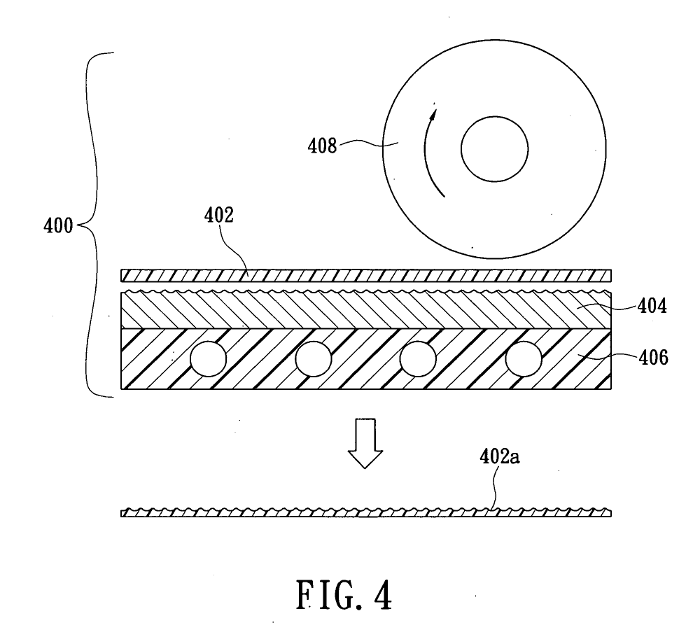

Reference is made to FIG. 4. In the second embodiment, the thin film 402 is placed on the first mold 404. One surface of the first mold 404 has a texture. Next, the heater 406 heats the thin film 402. The second mold 408 is a roller. The roller is a smooth surface. Finally, by using the roller to reprint the thin film 402, the thin film 402a with the texture is produced by utilizing the texture on the first mold 404.

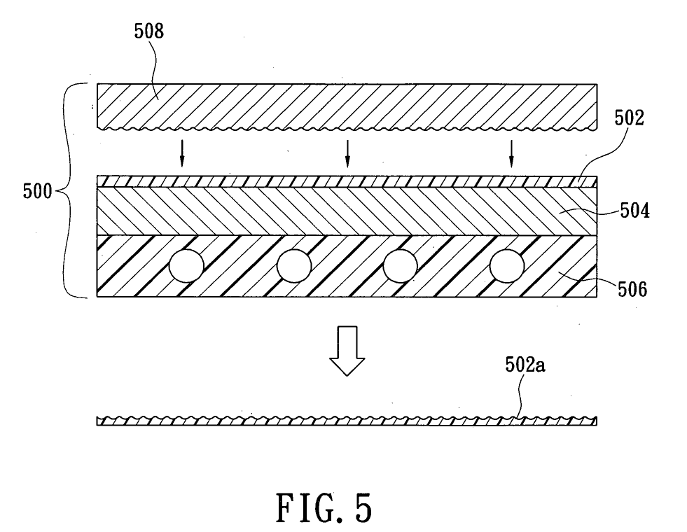

Reference is made to FIG. 5. In the third embodiment, the thin film 502 is placed on the first mold 504. The first mold 504 is a smooth surface. Next, the heater 506 heats the thin film 502. The second mold 508 is a board. One surface of the board has a texture. Finally, by using the board to reprint the thin film 502, the thin film 502a with the texture is produced by utilizing the texture on the second mold 508.

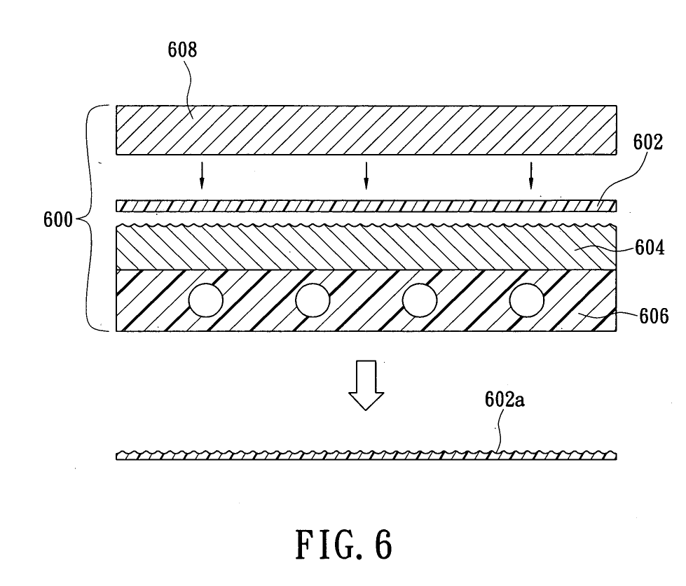

Reference is made to FIG. 6. In the fourth embodiment, the thin film 602 is placed on the first mold 604. One surface of the first mold 604 has a texture. Next, the heater 606 heats the thin film 602. The second mold 608 is a board. The board is a smooth surface. Finally, by using the board to reprint the thin film 602, the thin film 602a with the texture is produced by utilizing the texture on the first mold 604.

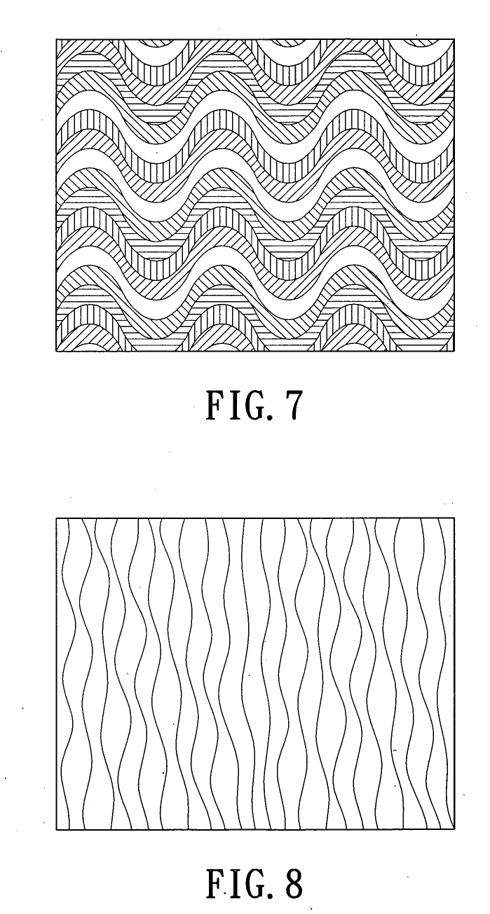

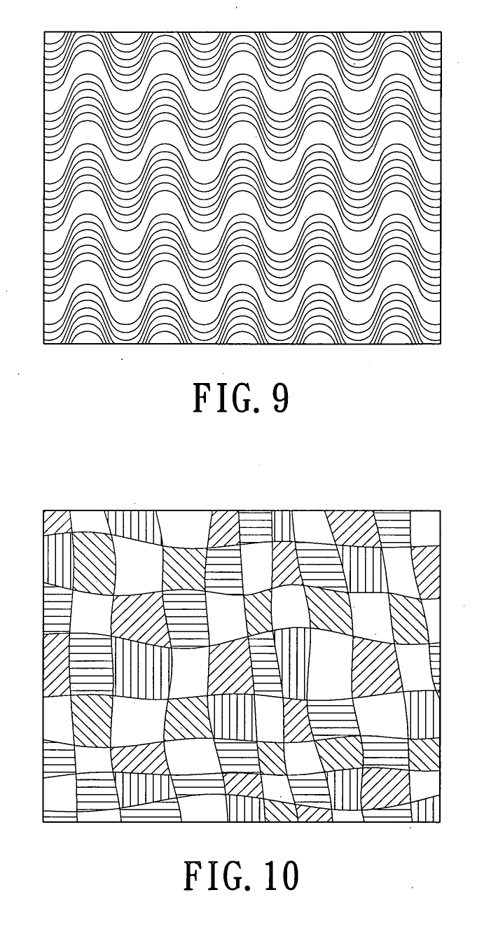

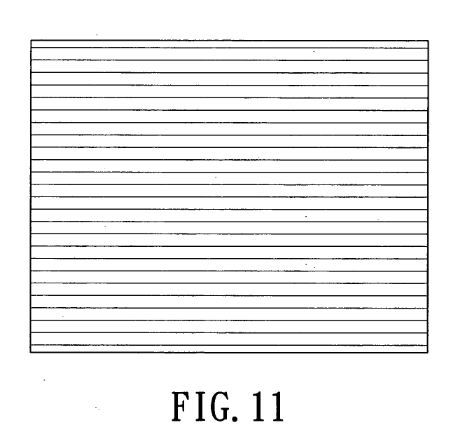

Reference is made to FIGS. 7˜11, which shows the different textures of the products. FIG. 7 is a S-curved texture. FIG. 8 and FIG. 9 are wave-shaped textures. FIG. 10 is a screen-shaped texture. FIG. 11 is a line-shaped texture. There is no pull molding symptom on the side walls and the corners of the product. These products provide the visible effect to the user, and have the three-dimensional touch feeling.

The present invention has the following characteristics:

1. The design of the mold is preserved. By changing the texture of the thin film, the appearance of the product can be determined according to the requirements.

2. The product provides the visible effect to the user, and has the three-dimensional touch feeling (i.e. 3D texture).

3. The original equipment manufacturer (OEM), or the original design manufacturer (ODM) can control the manufacturing process by himself or herself, and does not need the support from the manufacturer of Japan. The design can be implemented more flexibly. The manufacturing schedule can be determined by himself or herself.

4. Comparing using the new material with the texture, the present invention can reduce the cost. The order quantity can be limited to a minimum quantity due tot the material cost. The present invention can be applied to the customer-designed products.

5. Comparing to the prior art that uses the texture of the mold of the injection molding machine to produce the three-dimensional texture, the present invention injects the thin film with the texture to produce the product. The texture on the mold can be changed. The texture can be produced via the three-dimensional wrap by cooperating with the thin film. The pull molding symptom on the side walls and the corners of the product is overcome.

The description above only illustrates specific embodiments and examples of the present invention. The present invention should therefore cover various modifications and variations made to the herein-described structure and operations of the present invention, provided they fall within the scope of the present invention as defined in the following appended claims.

1-15. (canceled)

16. An in-mold reprint manufacturing method for thin film texture, comprising:
moving a thin film to the surface of a first mold;
heating the thin film;
using a second mold and the first mold to press onto the thin film to produce the texture on the thin film; and
injecting the thin film with the texture to produce a product with the texture.

17. The in-mold reprint manufacturing method for thin film texture as claimed in claim 16, wherein the first mold is a board, the second mold is a roller, the board is a smooth surface, and one surface of the roller has a texture.

18. The in-mold reprint manufacturing method for thin film texture as claimed in claim 17, wherein the heating temperature of the step of heating the thin film is between 200° and 300° .

19. The in-mold reprint manufacturing method for thin film texture as claimed in claim 16, wherein the first mold is a board, the second mold is a roller, one surface of the board has a texture, and the roller is a smooth surface.

20. The in-mold reprint manufacturing method for thin film texture as claimed in claim 19, wherein the heating temperature of the step of heating the thin film is between 200° and 300° .

21. The in-mold reprint manufacturing method for thin film texture as claimed in claim 16, wherein the first mold is a board, the second mold is another board, the board is a smooth surface, and one surface of the another board has a texture.

22. The in-mold reprint manufacturing method for thin film texture as claimed in claim 21, wherein the heating temperature of the step of heating the thin film is between 200° and 300° .

23. The in-mold reprint manufacturing method for thin film texture as claimed in claim 16, wherein the first mold is a board, the second mold is another board, one surface of the board has a texture, and the another board is a smooth surface.

24. The in-mold reprint manufacturing method for thin film texture as claimed in claim 23, wherein the heating temperature of the step of heating the thin film is between 200° and 300° .
